(19) United States
(12) Patent Application Publication
(10) Pub. No.: US 2006/0205912 A1
(43) Pub. Date: Sep. 14, 2006

(54) Poly(urethane carbonate)polyols

(75) Inventors: Hartmut Nefzger, Pulheim (DE); Manfred Schmidt, Dormagen (DE); James-Michael Barnes, Breitscheid (DE); Erika Bauer, Juchen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/369,811

(22) Filed: Mar. 7, 2006

(30) Foreign Application Priority Data
Mar. 12, 2005 (DE) 102005011448.2

(51) Int. Cl. C08G 18/00

(52) U.S. Cl. 528/44

(57) ABSTRACT

The present invention relates to poly(urethane carbonate) polyols, to a process for their preparation and to their use.

### FIELD OF THE INVENTION

The present invention relates to poly(urethane carbonate) polyols, to a process for their preparation and to their use.

### BACKGROUND OF THE INVENTION

Homopolymeric or copolymeric, hydroxy-functional, aliphatic polycarbonates are known. They are used in the field of high-quality polyurethane materials having high hydrolytic stability. They are normally prepared from non-vicinal diols by reaction with diaryl carbonate (DE-A 19 15 908) or dialkyl carbonate (DE A 25 55 805). It is further possible to prepare aliphatic polycarbonate diols from non-vicinal diols by reaction with dioxolanones (DE-OS 25 23 352), phosgene (DE-OS 15 95 446), bischloroformates (DE-OS 8 57 948) or urea (Angew. Chem. 92 (1980) 742). The polycarbonate polyol based solely or predominantly on 1,6-hexanediol has, in particular, acquired relatively great commercial importance. Accordingly, for example, high-quality polyurethane elastomers or lacquers are produced using polycarbonate diols based on 1,6-hexanediol.

The hydrolytic stability of polyurethanes produced from such polycarbonate polyols is particularly outstanding. It is far superior to that of analogous products made from polyadipate polyols. Pure hexanediol polycarbonates having number-average molecular weights of from 500 to 5000 are waxy substances having a softening temperature range of approximately from 45 to 55° C., depending on the molecular weight. Accordingly, the polyurethanes produced therefrom exhibit an increased modulus of transverse elasticity at low temperatures, that is to say they lose their flexibility. For this reason, polycarbonate diols have been developed that are intended to compensate for this disadvantage. Examples which may be mentioned include oligoesters based on adipic acid (DE-OS 19 64 998), oligoesters based on caprolactone (DE-OS 17 70 245) or low molecular weight adipates (EP-A 364 052), oligomeric tetraethylene glycols (DE-OS 22 21 751) and tetrabutylene glycols. A disadvantage of these structural units is their readily hydrolyzable ester group or their increased hydrophilicity, which results at least in more pronounced swelling of the PUR molded bodies produced therefrom. Polyether carbonates containing ether groups in turn exhibit reduced resistance to weathering.

Polycarbonate polyols based on so-called dimer diols (C₃₆ mixtures) have also been described (US-A 5,621,065), which polyols yield polycarbonates having a reduced melting point and a reduced viscosity even in admixture with, for example, 1,6-hexanediol. Although copolycarbonate polyols based on short-chained diols are likewise liquid at room temperature, they usually have a comparatively high viscosity.

Finally, there are also described in the literature polyurethane carbonates that are prepared by reaction of polycarbonates with low molecular weight diamines (EP-A 624 614). Such polyols also contain free amino end groups. When amino alcohols are used (DE-A 196 19 237), on the other hand, polyurethane carbonates having hydroxyl end groups are obtained.

Both the last-mentioned methods of preparing polyurethane carbonate polyols have the disadvantage, however, that they are reactions that lower the molecular weight, that is to say the greater the proportion of the diamine or amino alcohol, the higher must be the molecular weight, and hence the more complicated the preparation, of the polycarbonate used as starting compound. A further disadvantage is that, in amino alcohols, only half of the functional groups, namely the amino groups, participate in the reaction. In order to build up a particular content of urethane groups, twice the amount of amino alcohol must be used compared to the corresponding diamine, which in turn has the immediate consequence that the polycarbonate to be used must likewise exhibit twice the molar mass if it is desired to obtain a polyurethane carbonate of given molar mass.

### SUMMARY OF THE INVENTION

The present invention overcomes these disadvantages and limitations in the preparation of polyurethane carbonates.

It has now been found that poly(urethane carbonate) polyols can be obtained by pre-reacting low molecular weight polyols with polyisocyanate to form a prepolymer having terminal OH groups and then polycondensing this prepolymer with carbonic acid derivatives. The invention accordingly provides poly(urethane carbonate) polyols and a process for their preparation.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

The poly(urethane carbonate) polyols according to the invention have terminal hydroxyl groups and contain structural units of the general formulae {O—[R₁—O—C(O)—NH—R₂—NH—C(O)—O—]ₐR₁—O}ₙ and [—C(O)—O], wherein R₁ represents identical or different alkylene, cycloalkylene or oxaalkylene groups having from 4 to 12 carbon atoms, R₂ represents alkylene or cycloalkylene groups having from 6 to 14 carbon atoms, and a and n represent, based on the individual species, natural numbers or, based on the molecular ensemble, also fractional numbers. Preferred radicals R₁ are 1,4-butylene, 1,5-pentylene, 1,6-hexylene, 3-methyl-1,5-pentylene, 1,7-heptylene, 1,8-octylene, 1,9-nonylene, 1,10-decylene, 1,12-dodecylene, 3-oxa-1,5-pentylene, 3,6-dioxa-1,8-octylene, 3,6,9-trioxa-1,1 1-undecylene and 7-oxa-1,3-tridecylene. Preferred radicals R₂ are 1,6-hexylene, 1,8-octylene, isophorylene and 4,4′-dicyclohexylmethylene.

The poly(urethane carbonate) polyols according to the invention can be prepared by reacting aliphatic polyols and aliphatic polyisocyanates to form prepolymers having terminal hydroxyl groups and then polycondensing these prepolymers with carbonic acid derivatives.

In a particular embodiment of the invention, the poly(urethane carbonate) polyols according to the invention are obtained by polycondensing OH-terminated prepolymers of the formula
HO—[R₁—O—C(O)—NH—R₂—NH—C(O)—O—]ₐR₁—O—H
wherein
R₁ represents identical or different alkylene radicals of polyols,
R₂ represents identical or different alkylene radicals of polyisocyanates, and
a represents a natural number, based on the individual species, or a fractional mean value, based on the ensemble,
   with carbonate-forming compounds of the formula
   R₃—C(O)—R₄
   wherein
R₃, R₄ represent identical or different radicals chosen from oxyalkyl, oxyaryl, Cl, oxyalkylene and oxyarylene radicals.

The OH-terminated prepolymers are preferably prepared by reaction of low molecular weight polyols HO—R₁—OH with polyisocyanates OCN—R₂—NCO.

Examples of suitable low molecular weight polyols are 1,4-butanediol, 1,5-pentanediol, 1,6-hexanediol, 3-methylpentane-1,5-diol, 1,7-heptanediol, 1,8-octanediol, 1 ,9-nonanediol, 1,10-decanediol, 1,12-dodecanediol, oligomers of 1,6-hexanediol, of ethylene glycol and of propylene glycol, for example diethylene glycol, triethylene glycol, tetraethylene glycol, dipropylene glycol or tetrapropylene glycol. Furthermore, for the purposes of increasing the functionality, small amounts of trimethylolethane, trimethylolpropane or pentaerythritol can also be used concomitantly. It is further possible to use also so-called dimer diols (e.g. PRIPOL 2033 from Uniqema). Of course, hydroxyl-group-functional derivatives can also be used, which derivatives can be prepared from the low molecular weight polyols by esterification. Suitable reaction components for such esterified derivatives are, for example, the dicarboxylic acids succinic acid, glutaric acid and adipic acid, as well as phthalic acid and compounds derived from ε-caprolactone. It is, of course, also possible to use mixtures of representatives of the group of the low molecular weight polyols and their esterified derivatives.

Polyisocyanates suitable for the preparation of the OH-terminated prepolymers are aliphatic or cycloaliphatic, predominantly bifunctional isocyanates. Examples which may be mentioned include: 1,6-hexamethylene diisocyanate, 1,8-octamethylene diisocyanate, isophorone diisocyanate, cis,trans-4,4′-methylene-bis(cyclohexyl isocyanate), trans,trans-4,4′-methylene-bis(cyclohexyl isocyanate), and also NCO prepolymers prepared used these polyisocyanates. Of course, it is also possible to use mixtures of representatives of this group.

The preparation of the OH-terminated prepolymer is preferably carried out according to the invention at temperatures above 23° C., more preferably above 50° C., and most preferably from 60 to 135° C., the presence of a catalyst not being absolutely necessary. Normally, the reaction is carried out under nitrogen af normal pressure, but it can also be conducted under reduced or elevated pressure.

The molar mixing ratio of polyol component and polyisocyanate component is calculated according to the desired ratio of urethane groups to carbonate groups in the subsequent end product.

The OH-terminated prepolymer so obtained is further reacted with a carbonic acid derivative R₃—C(O)—R₄ from the group of the diaryl and dialkyl carbonates or of the α,ω-bischloroformates. Examples of suitable diaryl carbonates are diphenyl carbonate and ditolyl carbonate, suitable dialkyl carbonates are, for example, dimethyl carbonate and diethyl carbonate. Particular preference is given to diphenyl carbonate and dimethyl carbonate. Preferred α,ω-bischloroformates are those that can be prepared from low molecular weight polyols, particularly preferably 1,4-butanediol bischloroformate and 1,6-hexanediol bischloroformate, as well as the α,ω-bischloroformate of bisphenol A. Phosgene is also preferred.

In the process according to the invention, the OH-terminated prepolymers are reacted with the carbonic acid derivative R₃—C(O)—R₄, the temperature being from 120° C. to 220° C., preferably from 120° C. to 200° C., and a pressure of from 0.1 to 200 mbar, preferably from 0.1 to 100 mbar, being chosen. The carbonic acid derivative is used in a molar excess, the desired number-average molecular weight Mₙ of the poly(urethane carbonate) polyol being calculated according to the following formula:
Mₙ=n*Mₙ(OH prepolymer)+(n−1)*28
wherein
n represents the number of moles of OH-terminated prepolymer used and (n-1) represents the number of moles of carbonic acid derivative.

Mₙ(OH prepolymer), the number-average molecular weight of the OH-terminated prepolymer, is calculated from the stoichiometry of the reaction of low molecular weight polyols HO—R₁—OH with polyisocyanates OCN—R₂—NCO and is preferably from 90.5 to 1000 Da, more preferably from 91 to 800 Da, most preferably from 103 to 500 Da.

The number-average molecular weight Mₙ of the poly(urethane carbonate) polyol is preferably from 350 to 5000 Da, more preferably from 400 to 4000 Da, most preferably from 500 to 2500 Da.

The reaction can be catalyzed by bases or transition metal compounds. Examples which may be mentioned include: magnesium hydroxide carbonate, dibutyltin oxide, bis(tributyltin oxide), titanium tetrabutylate, ytterbium acetylacetonate.

Depending on the nature and the relative proportions of their structural components and on their molecular weight, the poly(urethane carbonate) polyols according to the invention are liquid, waxy-solid or highly crystalline at room temperature.

For example, the synthesis of an OH-terminated prepolymer from hexamethylene diisocyanate and hexanediol in a molar ratio of 1:4 and the reaction thereof with diphenyl carbonate yield a poly(urethane carbonate) polyol having an OH number of 50 mg KOH/g, the melting point of which is about 60° C. higher than that of an analogous poly(carbonate) polyol having the same OH number based only on hexanediol. A poly(urethane carbonate) polyol that has an analogous stoichiometric structure and is based on H₁₂-MDI as the polyisocyanate component, on the other hand, is completely amorphous and not capable of crystallization.

The poly(urethane carbonate) polyols according to the invention can be used in molecular-weight-building polyaddition or polycondensation reactions, for example as starting materials for the preparation of polyurethanes, for example polyurethane casting elastomers.

### EXAMPLES

The present invention is further illustrated, but is not to be limited, by the following examples.

### Example 1

1180 g (10 mol.) of 1,6-hexanediol were placed at 60° C. into a 4-liter four-necked flask equipped with a heating mantle, a stirrer, a thermometer, a dropping funnel, and a column (packed with Raschig rings) provided with a heatable distillation bridge. 420 g (2.5 mol.) of 1,6-hexamethylene diisocyanate were added dropwise, with stirring, by way of the dropping fimnel in such a manner that the temperature of the reaction mixture did not exceed 120° C. Stirring was continued for a further 2 hours to complete the reaction. 1379 g (6.44 mol.) of diphenyl carbonate were stirred in at 120° C. 60 mg of dibutyltin oxide were added, and heating was carried out for one hour at 180° C. The mixture was cooled to 120° C. and the pressure was lowered to 15 mbar. The phenol that had formed previously was distilled off. The reaction temperature was slowly raised to 200° C., during which phenol distilled off steadily. After about 10 hours, the temperature of 200° C. had been reached and the phenol distillation came to a halt. The pressure was lowered to 0.5 mbar and final residues of phenol were removed.
Phenol yield: 1204 g , theory: 1210 g (12.89 mol.).
OH number: 50.6 mg KOH/g, melting range 100-120° C.

### Example 2

1180 g (10 mol.) of 1,6-hexanediol were placed at 60° C. into a 4-liter four-necked flask equipped with a heating mantle, a stirrer, a thermometer, a dropping funnel, and a column (packed with Raschig rings) provided with a heatable distillation bridge. 420 g (2.5 mol.) of 1,6-hexamethylene diisocyanate were added dropwise, with stirring, by way of the dropping funnel in such a manner that the temperature of the reaction mixture did not exceed 120° C. Stirring was continued for a further 2 hours to complete the reaction. 1177 g (5.5 mol.) of diphenyl carbonate were stirred in at 120° C. 60 mg of dibutyltin oxide were added, and heating was carried out for one hour at 180° C. The mixture was cooled to 120° C. and the pressure was lowered to 15 mbar. The phenol that had formed previously was distilled off. The reaction temperature was slowly raised to 200° C., during which phenol distilled off steadily. After about 10 hours, the temperature of 200° C. had been reached and the phenol distillation came to a halt. The pressure was lowered to 0.5 mbar and final residues of phenol were removed.
Phenol yield: 1034 g, theory: 1034 g (11 mol.).
OH number: 113.9 mg KOH/g, melting range 100-120° C.

### Example 3

1180 g (10 mol.) of 1,6-hexanediol were placed at 60° C. into a 4-liter four-necked flask equipped with a heating mantle, a stirrer, a thermometer, a dropping funnel, and a column (packed with Raschig rings) provided with a heatable distillation bridge. 655 g (2.5 mol.) of H₁₂-MDI (DESMODUR W, Bayer AG) were added dropwise, with stirring, by way of the dropping funnel in such a manner that the temperature of the reaction mixture did not exceed 120° C. Stirring was continued for a further 2 hours to complete the reaction. 1335 g (6.24 mol.) of diphenyl carbonate were stirred in at 120° C. 60 mg of dibutyltin oxide were added, and heating was carried out for one hour at 180° C. The mixture was cooled to 120° C. and the pressure was lowered to 15 mbar. The phenol that had formed previously was distilled off. The reaction temperature was slowly raised to 200° C., during which phenol distilled off steadily. After about 10 hours, the temperature of 200° C. had been reached and the phenol distillation came to a halt. The pressure was lowered to 0.5 mbar and final residues of phenol were removed.
Phenol yield: 1161 g , theory: 1173 g (12.48 mol.).
OH number: 54.5 mg KOH/g. Glass transition temperature: −49° C.

### Example 4

1180 g (10 mol.) of 1,6-hexanediol were placed at 60° C. into a 4-liter four-necked flask equipped with a heating mantle, a stirrer, a thermometer, a dropping funnel, and a column (packed with Raschig rings) provided with a heatable distillation bridge. 420 g (2.5 mol.) of isophorone diisocyanate were added dropwise, with stirring, by way of the dropping funnel in such a manner that the temperature of the reaction mixture did not exceed 120° C. Stirring was continued for a further 2 hours to complete the reaction. 1442 g (6.27 mol.) of diphenyl carbonate were stirred in at 120° C. 60 mg of dibutyltin oxide were added, and heating was carried out for one hour at 180° C. The mixture was cooled to 120° C. and the pressure was lowered to 15 mbar. The phenol that had formed previously was distilled off. The reaction temperature was slowly raised to 200° C., during which phenol distilled off steadily. After about 10 hours, the temperature of 200° C. had been reached and the phenol distillation came to a halt. The pressure was lowered to 0.5 mbar and final residues of phenol were removed.
Phenol yield: 1179 g , theory: 1168 g (12.54 mol.).
OH number: 61.5 mg KOH/g, glass transition temperature: −11.5° C.

### Example 5

1832 g (10 mol.) of hexanediol ether (partially etherified hexanediol having an OH number of 551 mg KOH/g) were placed at 60° C. into a 4-liter four-necked flask equipped with a heating mantle, a stirrer, a thermometer, a dropping ftmnel, and a column (packed with Raschig rings) provided with a heatable distillation bridge. 151 g (0.9 mol.) of hexamethylene diisocyanate were added dropwise, with stirring, by way of the dropping funnel in such a manner that the temperature of the reaction mixture did not exceed 120° C. Stirring was continued for a further 2 hours to complete the reaction. 1412 g (6.6 mol.) of diphenyl carbonate were stirred in at 120° C. 80 mg of dibutyltin oxide were added, and heating was carried. out for one hour at 180° C. The mixture was cooled to 120° C. and the pressure was lowered to 15 mbar. The phenol that had formed previously was distilled off. The reaction temperature was slowly raised to 200° C., during which phenol distilled off steadily. After about 10 hours, the temperature of 200° C. had been reached and the phenol distillation came to a halt. The pressure was lowered to 0.5 mbar and fmal residues of phenol were removed.
Phenol yield: 1238 g , theory: 1241 g (13.2 mol.).
OH number: 74 mg KOH/g, theoret. 78 mg KOH/g, viscosity: 760 mPas (75° C.).
End group analysis: phenylcarbonato 0.14 wt.%, phenoxy 0.01 wt.%.

Preparation of a prepolymer:

602 g of this polyurethane carbonate polyol (OH number 74 mg KOH/g) were stirred at 75° C., under nitrogen, into 398 g of 4,4′-diphenylmethane diisocyanate (DESMODUR 44M, Bayer MaterialScience AG) and reacted for 2 hours at 80° C. The NCO content was determined as 9.94 wt.% NCO (theory: 10.0 wt.%) or 9.74 wt.% after 72 hours' storage at 80° C. The viscosity was 1880 mPas (70° C.) directly after the preparation and 2190 mPas (70° C.) after 72 hours' storage at 80° C.

Preparation of a casting elastomer

200 g of this NCO prepolymer were heated to 80° C. and degassed for 2 hours in vacuo. 20.5 g of 1,4-butanediol were stirred in such that the reacting melt remained free of bubbles. After 20 seconds, the mixture was poured into molds which had been preheated to 100° C. and pretreated with mold-release agent, and was allowed to react for 16 hours at 110° C. in a drying cabinet. After 21 days' storage at room temperature, the following mechanical properties were determined:
Hardness: 95 ShoreA, 45 ShoreD
Tear growth resistance: 29 kN/m
Rebound resilience: 30%

Stress-strain behavior:

| Elongation | Tension |
|---|---|
| [%] | [MPa] |
| 10 | 6 |
| 20 | 8.5 |
| 40 | 11.5 |
| 100 | 18 |
| 200 | 34.5 |

Tension at tear: 49 MPa
Elongation at tear: 285%
Melting range: 160-190° C., maximum: 171° C. (DSC)

Further physical properties of the resulting polyurethane carbonate polyols are summarized below in Table 1.

TABLE 1

| | Example | | | | |
|---|---|---|---|---|---|
| | 1 | 2 | 3 | 4 | 5 |
| OH number [mg KOH/g] | 50.6 | 113.9 | 54.5 | 61.5 | 74 |
| Viscosity/50% in DMA¹ | n.d. | 120 | 170 | 97 | n.d. |
| [mPas@50° C.] | | | | | |
| Viscosity without solvent | n.d. | n.d. | n.d. | n.d. | 760 |
| [mPas@50° C.] | | | | | |
| Melting range [° C.] | 100-120 | 100-120 | n.d. | n.d. | n.d. |
| Glass transition temperature | n.d. | −49 | −9 | −11.5 | n.d. |
| [° C.] | | | | | |
| Solubility in DMA [at | n.d. | slightly | clear | clear | clear |
| 25° C.] | | cloudy | | | |

¹DMA: N,N-dimethylacetamide

Although the invention has been described in detail in the foregoing for the purpose 5 of illustration, it is to be understood that such detail is solely for that purpose and that variations can be made therein by those skilled in the art without departing from the spirit and scope of the invention except as it may be limited by the claims.

What is claimed is:

1. A poly(urethane carbonate) polyol having terminal hydroxyl groups, comprising structural units of the formulae
{O—[R₁—O—C(O)—NH—R₂—NH—C(O)—O—]ₐR₁—O}ₙ and [—C(O)—O],
wherein
R₁ represents identical or different alkylene, cycloalkylene or oxaalkylene groups having from 4 to 12 carbon atoms,
R₂ represents alkylene or cycloalkylene groups having from 6 to 14 carbon atoms, and
a and n represent, based on the individual species, natural numbers or, based on the molecular ensemble, fractional mean values.

2. The poly(urethane carbonate) polyol according to claim 1, wherein R₁ is chosen from 1,4—butylene, 1,5-pentylene, 1,6-hexylene, 3-methyl-1,5-pentylene, 1,7-heptylene, 1,8-octylene, 1,9-nonyiene, 1,10-decylene, 1,12-dodecylene, 3-oxa-1,5-pentylene, 3,6-dioxa-1,8-octylene, 3,6,9-trioxa-1,11-undecylene and 7-oxa-1,3-tridecylene.

3. The poly(urethane carbonate) polyol according to claim 1, wherein R₂ is chosen from 1,6-hexylene, 1,8-octylene, isophorylene and 4,4′-dicyclohexylmethylene.

4. The poly(urethane carbonate) polyol according to claim 1 having a number-average molecular weight Mₙ of from about 350 to about 5000 Da.

5. The poly(urethane carbonate) polyol according to claim 1 having a number-average molecular weight Mₙ of from about 400 to about 4000 Da.

6. The poly(urethane carbonate) polyol according to claim 1 having a number-average molecular weight Mₙ of from about 500 to about 2500 Da.

7. A process for the preparation of the poly(urethane carbonate) polyol according to claim 1, comprising
reacting an aliphatic polyol and an aliphatic or cycloaliphatic polyisocyanate to form a prepolymer having terminal hydroxyl groups; and
polycondensing the prepolymer with a carbonic acid derivative.

8. The process according to claim 7, wherein the aliphatic polyol is chosen from 1,4-butanediol, 1,5-pentanediol, 1,6-hexanediol, 3-methylpentane-1,5-diol, 1,7-heptanediol, 1,8-octanediol, 1,9-nonanediol, 1,10-decanediol, 1,12-dodecanediol, oligomers of 1,6-hexanediol, oligomers of ethylene glycol oligomers of propylene glycol.

9. The process according to claim 7, wherein the aliphatic or cycloaliphatic isocyanate is chosen from 1,6-hexamethylene diisocyanate, 1,8-octamethylene diisocyanate, isophorone diisocyanate, cis,trans-4,4′-methylene-bis(cyclohexyl isocyanate) and trans,trans-4,4′-methylene-bis(cyclohexyl isocyanate).

10. The process according to claim 7, wherein the carbonic acid derivative is chosen from diphenyl carbonate, ditolyl carbonate, dimethyl carbonate and diethyl carbonate.

11. In a molecular-weight-building polyaddition or a polycondensation reaction, the improvement comprising including the poly(urethane carbonate) polyol according to claim 1.

12. In a process for the preparation of a foamed or a solid polyurethane, the improvement comprising including the poly(urethane carbonate) polyol according to claim 1.

13. A process for the production of a poly(urethane carbonate) polyol comprising polycondensing an OH-terminated prepolymer of the formula
HO—[R₁—O—C(O)—NH—R₂—NH—C(O)—O—]ₐR₁—O—H
wherein
R₁represents identical or different alkylene radicals of polyols,
R₂ represents identical or different alkylene radicals of polyisocyanates, and
a represents a natural number, based on the individual species, or a fractional mean value, based on the ensemble,
with a carbonate-forming compound of the formula
R₃—C(O)-R4
wherein
R₃,R₄ represent identical or different radicals chosen from oxyalkyl, oxyaryl, Cl, oxyalkylene and oxyarylene radicals.

14. The poly(urethane carbonate) polyol according to claim 13, wherein R₁ is chosen from 1,4-butylene, 1,5-pentylene, 1,6-hexylene, 3-methyl-1,5-pentylene, 1,7-heptylene, 1,8-octylene, 1,9-nonylene, 1,10-decylene, 1,12-dodecylene, 3-oxa-1,5-pentylene, 3,6-dioxa-1,8-octylene, 3,6,9-trioxa-1, 11-undecylene and 7-oxa-1,3-tridecylene.

15. The poly(urethane carbonate) polyol according to claim 13, wherein R₂ is chosen from 1,6-hexylene, 1,8-octylene, isophorylene and 4,4′-dicyclohexylmethylene.

16. The poly(urethane carbonate) polyol according to claim 13 having a number-average molecular weight Mₙ of from about 350 to about 5000 Da.

17. The poly(urethane carbonate) polyol according to claim 13 having a number-average molecular weight Mₙ of from about 400 to about 4000 Da.

18. The poly(urethane carbonate) polyol according to claim 13 having a number-average molecular weight Mₙ of from about 500 to about 2500 Da.

19. The a poly(urethane carbonate) polyol made by the process according to claim 13.
